(19) United States
(12) Patent Application Publication
(10) Pub. No.: US 2008/0038645 A1
(43) Pub. Date: Feb. 14, 2008

(54) Cell or battery with a metal lithium electrode and electrolytes therefor

(76) Inventors: Vladimir Kolosnitsyn, Ufa (RU); Elena Karaseva, Ufa (RU)

Correspondence Address: PEARL COHEN ZEDEK LATZER, LLP, 1500 BROADWAY 12TH FLOOR, NEW YORK, NY, 10036, US

(21) Appl. No.: 11/889,334

(22) Filed: Aug. 10, 2007

Related U.S. Application Data
(60) Provisional application No. 60/854,097, filed on Oct. 25, 2006.

(30) Foreign Application Priority Data
Aug. 10, 2006 (GB) GB 0615870.3

(51) Int. Cl. H01M 10/00

(52) U.S. Cl. 429/338; 429/188; 429/199; 429/337; 429/341; 429/342

(57) ABSTRACT

An electrolyte for rechargeable batteries with a negative electrode of lithium or lithium containing alloys comprising: one or several non-aqueous organic solvents, one or several lithium salts and one or several additives increasing the cycle life of the lithium electrode. The electrolyte solution may comprise one or several solvents selected from the group comprising: tetrahydrofurane, 2-methyltetrahydrofurane, dimethylcarbonate, diethylcarbonate, ethylmethylcarbonate, methylpropylcarbonate, methylpropylpropyonate, ethylpropylpropyonate, methylacetate, ethylacetate, propylacetate, dimetoxyethane, 1,3-dioxalane, diglyme (2-methoxyethil ether), tetraglyme, ethylenecarbonate, propylencarbonate, γ-butyrolactone, and sulfolane. The electrolyte solution may further comprise at least one salt or several salts selected from the group consisting of lithium hexafluorophosphate (LiPF₆), lithium hexafluoroarsenate (LiAsF₆), lithium perchlorate (LiClO₄), lithium sulfonylimid trifluoromethane (LiN(CF₃SO₂)₂)) and lithium trifluorosulfonate (CF₃SO₃Li) or other lithium salts or salts of another alkali metal or a mixture thereof. Also disclosed is an electrochemical cell or battery with an anode of metallic lithium or a lithium-containing alloy, and such an electrolyte.

### PRIOR APPLICATION DATA

The present application claims priority from prior U.S. provisional application Ser. No. 60/854,097, filed Oct. 25, 2006, entitled “Electrolyte for Batteries With a Metal Lithium Electrode”, and from United Kingdom application GB 0615870.3 filed 10 Aug. 2006, each incorporated by reference herein in its entirety.

### TECHNICAL FIELD

The present invention relates to electrochemical power engineering, and in particular to secondary chemical sources of electric energy (rechargeable batteries) comprising a negative electrode (anode) made of metallic lithium or lithium-containing alloys. The present invention also relates to methods of increasing of lithium electrode cycle life by way of particular electrolytes.

### BACKGROUND OF THE INVENTION

Metallic lithium possesses a high specific capacity (3.88 Ah/g) and is thus one of the most attractive materials for forming negative electrodes of high capacity rechargeable batteries.

A short cycle life is known to be one of the weak points of lithium metal electrodes, this being caused by the tendency of lithium to form dendrites during cathode deposition.

It is known that electrochemical systems based on metallic lithium and nonaqueous electrolytes are not thermodynamically stable. Therefore a film of the products of lithium interaction with electrolyte components is always formed on the surface of a lithium electrode. The properties of this film are determined by the chemical properties of components of the electrolyte system. A passivating film on the surface of the lithium electrode may be formed in many electrolytes and possesses high ion conductivity for lithium ions as well as good protection properties against the electrolyte itself. In some cases, such films are termed “Solid Electrolyte Interface”. Since they have high conductivity for lithium ions and low electron conductivity, they protect metallic lithium from subsequent interactions with electrolyte components and at the same time do not impede the passage of electrochemical reactions. During cathode polarization, some lithium is plated onto the anode under the passivating layer. Such plated lithium produces compact deposits well-bound to the bulk of the anode (“compact lithium”). Further lithium is deposited in the form of dendrites in those areas of the passivating film which contain defects or impurities (“dendrite lithium”). During the interaction of compact and dendrite lithium with components of the electrolyte system, some of the lithium forms thermodynamically stable, hardly soluble compounds (oxides and fluorides) (“chemically bound lithium”). The balance between compact, dendrite and chemically bound lithium is determined by the state of the electrode surface, by the composition and properties of the electrolyte system, by regimes of polarization and by the properties of the base anode material to which lithium is plated during cathode deposition. Ultimately it is this balance that determines the efficiency of lithium cycling.

During anode polarization the compact lithium is dissolved, and the dendrite lithium is partially dissolved in those areas where it has a good electron contact with the base material. The non-dissolved part of the dendrite lithium forms a finely dispersed powder which is accumulated on the surface of the lithium electrode.

### SUMMARY OF THE INVENTION

A method for increasing the cycle life of lithium metal is proposed in the present invention. It is proposed to add lithium polysulfides into electrolyte systems and to conduct charging (anode deposition of lithium) under conditions such that the rate of lithium dendrite formation is equal to or lower than the rate of lithium dissolution occurring due to the interaction with lithium polysulfides dissolved in the electrolyte.

In one embodiment, an electrolyte for rechargeable batteries may have a negative electrode comprising for example lithium or lithium containing alloys, and the electrode may include one or several non-aqueous organic solvents; one or several lithium salts; and one or several additives increasing the cycle life of the electrode. The solvents may be for example selected from the group consisting of: tetrahydrofurane, 2-methyltetrahydrofurane, dimethylcarbonate, diethylcarbonate, ethylmethylcarbonate, methylpropylcarbonate, methylpropylpropyonate, ethylpropylpropyonate, methylacetate, ethylacetate, propylacetate, dimetoxyethane, 1,3-dioxalane, diglyme (2-methoxyethil ether), tetraglyme, ethylenecarbonate, propylencarbonate, γ-butyrolactone, and sulfolane. The electrolyte may include one or more alkali metal salts. The lithium salts may be selected from the group consisting of lithium hexafluorophosphate (LiPF₆), lithium hexafluoroarsenate (LiAsF₆), lithium perchlorate (LiClO₄), lithium sulfonylimid trifluoromethane (LiN(CF₃SO₂)₂)) and lithium trifluorosulfonate (CF₃SO₃Li). The additives may be lithium polysulfides having the formula Li₂Sₙ. The value of n may be for example from 2 and 20, inclusive. Other suitable values may be used.

The concentration of the one or several lithium salts may for example lie in the range from 0.1 to 90% of a concentration of a saturated solution of the used salt (salts) in an aprotic solvent (solvents mixture). The concentration of lithium polysulfides may be for example from 0.01M to 90% of a concentration of a saturated solution of the used salt (salts) in an aprotic solvent (solvents mixture). Other concentrations may be used. The % value may be for example a % of the saturation concentration.

### BRIEF DESCRIPTION OF THE DRAWINGS

The present invention will be understood and appreciated more fully from the following detailed description taken in conjunction with the drawings in which:

FIG. 1 depicts a cell polarization according to one embodiment; and

FIG. 2 depicts a cell polarization according to one embodiment.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

According to one embodiment of the present invention, there is provided an electrolyte for rechargeable batteries with a negative electrode (anode) made of lithium or lithium-containing alloys including one or several non-aqueous organic solvents, one or several lithium salts and one or several additives increasing the cycle life of the lithium electrode.

In one embodiment, the electrolyte solution comprises at least one solvent or several solvents selected from the group comprising: tetrahydrofurane, 2-methyltetrahydrofurane, dimethylcarbonate, diethylcarbonate, ethylmethylcarbonate, methylpropylcarbonate, methylpropylpropyonate, ethylpropylpropyonate, methylacetate, ethylacetate, propylacetate, dimetoxyethane, 1,3-dioxalane, diglyme (2-methoxyethil ether), tetraglyme, ethylenecarbonate, propylencarbonate, γ-butyrolactone, and sulfolane.

In one embodiment, the electrolyte solution comprises at least one salt or several salts selected from the group consisting of lithium hexafluorophosphate (LiPF₆), lithium hexafluoroarsenate (LiAsF₆), lithium perchlorate (LiClO₄), lithium sulfonylimid trifluoromethane (LiN(CF₃SO₂)₂)) and lithium trifluorosulfonate (CF₃SO₃Li) or other lithium salts or salts of another alkali metal or a mixture thereof.

In one embodiment, the electrolyte additives are advatageously lithium polysulfides having the formula Li₂Sₙ.

In one embodiment, The value of n in the lithium polysulfides preferably lies in the region from 2 to 20 inclusive, or from 2 to 12 inclusive, or from 12 to 20 inclusive.

In one embodiment, the concentration of lithium salt (salts) lies in the range from 0.1 to 90% of a concentration of a saturated solution of the used salt (salts) in an aprotic solvent (solvents mixture).

In one embodiment, the lithium polysulfide concentration is from 0.01M to 90% of a concentration of a saturated solution of the used salt (salts) in an aprotic solvent (solvents mixture).

It will be understood that saturation concentrations of the salt will depend on the particular salt/solvent system used, and also on temperature and pressure. However, it is the concentration of the salt or the lithium polysulfide relative to the saturation concentration at the prevailing operating conditions that is of importance, which is why the relative concentrations in % age terms are used to define the upper concentration limits. With regard to the lower polysulfide concentration limit, at least a minimum absolute concentration of 0.01M is preferred.

According one embodiment of the present Invention, there is provided an electrochemical cell or battery comprising a negative electrode (anode) made of metallic lithium or a first lithium-containing alloy, and an electrolyte according to the first aspect.

The cell or battery may include a positive electrode (cathode) made of metallic lithium or a second lithium-containing alloy, different to or the same as the first lithium-containing alloy.

Some embodiments of the invention are adapted for operation at standard temperature and pressure, that is, 25° C. and 1 atm.

Other embodiments may be adapted for operation in other temperature ranges, for example −40 to +150° C., −20 to +110° C., or −10 to +50° C. Other temperatures and pressures and ranges thereof may be useful.

Several approaches may be used to solve the problem of improving the cycle life of a lithium electrode.

A first approach is based on the formation of hard electrolyte films (organic or non-organic) on the surface of the lithium electrode. Such films have a number of necessary properties:
high lithium ion conductivity;
high lithium ion transport numbers;
low electron conductivity;
good mechanical properties (strength and elasticity);
high adhesion to the surface of metallic lithium.

The films of solid electrolyte can be formed during contact of metallic lithium with electrolyte components; and/or they can be specially formed during the process of lithium electrode production (for example by polymerization of monomers from the gas phase or by vacuum deposition of various substances such as silicon). The main disadvantage of this approach is the gradual deterioration of the properties of such protection films during the cycle life of a lithium electrode.

A second approach involves adding special components into the electrolytes. All possible additives can be roughly divided into 2 large groups according to their mechanism of action:

1. Surface active agents. These are adsorbed from the solution onto the lithium electrode surface and produce protective films (layers). Such types of additives protect the lithium electrode surface against interaction with components of the electrolyte system while not preventing the transfer of lithium ions through the adsorbed layer and not preventing the passage of electrochemical reactions. Many various surface active compounds (such as alcohols) may be used as additives.

2. Chemically active (reactive) additives. It is possible to distinguish between:
Additives producing protective films with high ion conductivity on lithium surfaces during interaction with metallic lithium. Among such additives are various vinyl monomers in which polymerization can be initiated by ions or free radicals produced during cathode or anode polarization of lithium.
Alloy-producing additives. These represent metal compounds soluble in electrolytes and capable of producing alloys with metallic lithium by precipitating onto the anode during the process of cathode polarization at higher positive potentials than that of lithium deposition. Halides (halogenides) of calcium, magnesium and aluminum can be considered as such kind of compounds.
Oxidation-reduction additives producing (when reacting with metallic lithium) soluble compounds capable of reduction at the positive electrode during anode polarization. These are so-called dendrite “scavengers” or “solvents” of metal lithium.

The use of dendrite “scavengers” is one of the most efficient methods for improving the cycle life of a lithium electrode. The dendrite “scavengers” should possess a number of specific properties:

The oxidized form has to:
be well soluble in electrolyte;
be highly reactive towards metallic lithium;
penetrate easily through the passivating film on the lithium surface;
be inert towards other components of the electrolyte system.

The reduced form has to:
have limited solubility in electrolyte so as to form a protective film on lithium surface;
form a passivating film of reduction products possessing high lithium ion conductivity and low electron conductivity;
be easily oxidized on the positive electrode in the same or similar range of potentials as the oxidizing potential of the positive electrode depolarizer, but at the same time should not passivate it;
be inert towards the positive electrode depolarizer.

Sulfur and lithium polysulfides can be such dendrite “scavengers”. Indeed, in sulfide systems metallic lithium reacts either with sulfur (if it is dissolved in electrolyte) or with lithium polysulfides:

2Li+S₈→Li₂S₈

2Li+Li₂Sₙ→Li₂Sₙ₋₁+Li₂S↓

A film of hard soluble products, lithium sulfides, is formed in this process at the lithium surface. This film does not prevent the passage of electrochemical processes on the lithium electrode.

Lithium sulfides are capable of reacting with sulfur-producing, well-soluble compounds, lithium polysulfides. Lithium polysulfides are formed in liquid phase according to the reaction:

Li₂S+nS→Li₂Sₙ₊₁

The solubility of lithium polysulfides is significantly dependent on electron donor-acceptor properties and on the polarity of the solvents used, as well as on the length of the polysulfide chain, which in turn depends on the properties and concentration of solvent and electrolyte salt.

Lithium polysulfides as dendrite “scavengers” have a number of advantages when compared to other additives: they have a lower equivalent weight, possess good solubility forming long- and middle-chain polysulfides and have poorer solubility in the form of short-chain polysulfides.

### EXAMPLES

### Example 1

A cell was produced with two lithium electrodes, a separator Celgard 3501 (a trade mark of Tonen Chemical Corporation, Tokyo, Japan, also available from Mobil Chemical Company, Films Division, Pittsford, N.Y.), which was placed between the electrodes. The separator membrane was soaked with electrolyte before insertion into the cell. Lithium electrodes were produced from high purity lithium foil of 38 microns thickness (available from Chemetall Foote Corporation, USA). A copper foil was used as a current collector for the lithium electrodes. A 1M solution of lithium trifluoromethanesulfonate (available from 3M Corporation, St. Paul, Minn.) in sulfolane (99.8%, standard for GC available from Sigma-Aldrich, UK) was used as an electrolyte.

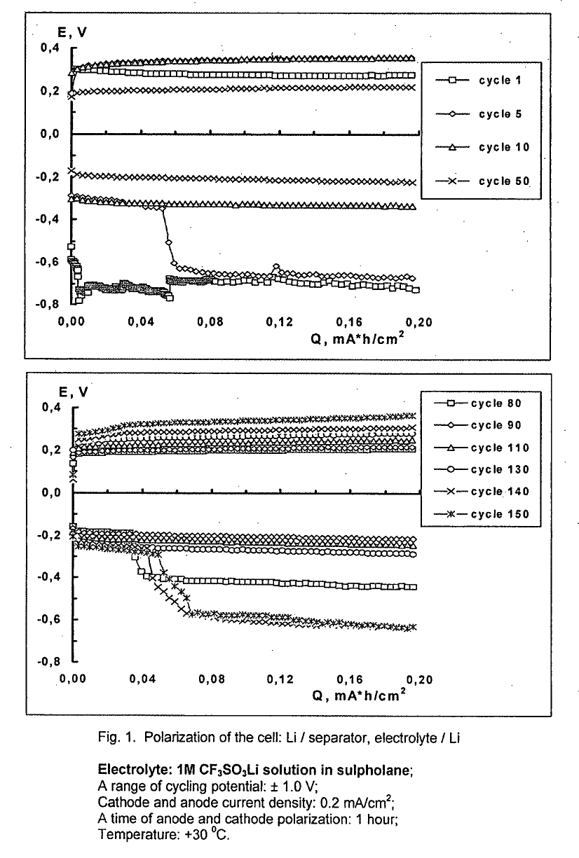

The cell was cycled on a battery tester Bitrode MCV 16-0.1-5 (Bitrode Corporation) at a current load of 0.2 mA/cm². Cathode and anode polarization was undertaken for 1 hour each. The chronopotentiograms obtained during cycling of this cell are shown in FIG. 1.

### Example 2

(Preparation of Lithium Polysulfide Containing Electrolyte)

2 g of sublimated sulfur, 99.5% (Fisher Scientific, UK) and 0.57 g of lithium sulfide, 98% (Sigma-Aldrich, UK) were ground together in a high speed mill (Microtron MB550) for 15 to 20 minutes in an atmosphere of dry argon (moisture content 20-25 ppm). The ground mixture of lithium sulfide and sulfur was placed into a flask and 50 ml of electrolyte was added to the flask. A 1M solution of lithium trifluoromethanesulfonate (available from 3M Corporation, St. Paul, Minn.) in sulfolane (99.8%, standard for GC available from Sigma-Aldrich, UK) was used as the electrolyte. The content of the flask was mixed for 24 hours by using a magnetic stirrer at room temperature. This was a way of making a 0.25M solution of lithium polysulfide Li₂S₆ in 1M solution of lithium trifluoromethanesulfonate in sulfolane.

### Example 3

As described in Example 1, there was produced an electrochemical cell with two lithium electrodes separated by Celgard 3501 soaked with the electrolyte from Example 2.

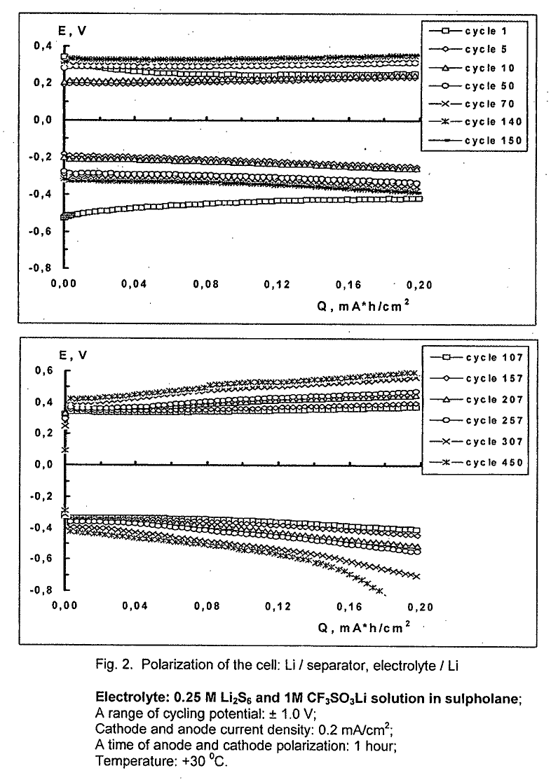

The cell was cycled on an MCV 16-0.1-5 battery tester (Bitrode Corporation) at a current load of 0.2 mA/cm². The time of cathode and anode polarization was 1 hour each. The chronopotentiograms obtained during the cycling of this cell are shown in FIG. 2.

A comparison of FIGS. 1 and 2 shows that addition of lithium polysulfide into the electrolyte composition leads to a more than threefold increase in the cycle life of a lithium electrode.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

It will be appreciated by persons skilled in the art that the present invention is not limited to what has been particularly shown and described hereinabove. Rather the scope of the present invention is defined only by the claims, which follow.

1. An electrolyte for rechargeable batteries with a negative electrode comprising lithium or lithium-containing alloys, the electrode comprising:
one or several non-aqueous organic solvents;
one or several lithium salts; and
one or several additives increasing the cycle life of the electrode.

2. An electrolyte as claimed in claim 1, wherein the solvents are selected from the group consisting of: tetrahydrofurane, 2-methyltetrahydrofurane, dimethylcarbonate, diethylcarbonate, ethylmethylcarbonate, methylpropylcarbonate, methylpropylpropyonate, ethylpropylpropyonate, methylacetate, ethylacetate, propylacetate, dimetoxyethane, 1,3-dioxalane, diglyme (2-methoxyethil ether), tetraglyme, ethylenecarbonate, propylencarbonate, γ-butyrolactone, and sulfolane.

3. An electrolyte as claimed in claim 1, the lithium salts are selected from the group consisting of lithium hexafluorophosphate (LiPF₆), lithium hexafluoroarsenate (LiAsF₆), lithium perchlorate (LiClO₄), lithium sulfonylimid trifluoromethane (LiN(CF₃SO₂)₂)) and lithium trifluorosulfonate (CF₃SO₃Li).

4. An electrolyte as claimed in claim 1, wherein the additives are lithium polysulfides having the formula Li₂Sₙ.

5. An electrolyte as claimed in claim 4, wherein the value of n is from 2 to 20, inclusive.

6. An electrolyte as claimed in claim 4, wherein the value of n is from 2 to 12, inclusive.

7. An electrolyte as claimed in claim 4, wherein the value of n is from 12 to 20, inclusive.

8. An electrolyte as claimed in claim 1, wherein the concentration of the one or several lithium salts lies in the range from 0.1 to 90% of a concentration of a saturated solution of the used salt (salts) in an aprotic solvent (solvents mixture).

9. An electrolyte as claimed in claim 4, wherein the concentration of lithium polysulfides is from 0.01M to 90% of a concentration of a saturated solution of the used salt (salts) in an aprotic solvent (solvents mixture).

10. An electrolyte as claimed in claim 1 comprising one or more alkali metal salts.

11. A battery comprising a negative electrode comprising lithium or lithium-containing alloys, the electrode comprising:
one or several non-aqueous organic solvents;
one or several lithium salts; and
one or several additives increasing the cycle life of the electrode.

12. A battery as claimed in claim 11, wherein the solvents are selected from the group consisting of: tetrahydrofurane, 2-methyltetrahydrofurane, dimethylcarbonate, diethylcarbonate, ethylmethylcarbonate, methylpropylcarbonate, methylpropylpropyonate, ethylpropylpropyonate, methylacetate, ethylacetate, propylacetate, dimetoxyethane, 1,3-dioxalane, diglyme (2-methoxyethil ether), tetraglyme, ethylenecarbonate, propylencarbonate, γ-butyrolactone, and sulfolane.

13. A battery as claimed in claim 11, the lithium salts are selected from the group consisting of lithium hexafluorophosphate (LiPF₆), lithium hexafluoroarsenate (LiAsF₆), lithium perchlorate (LiClO₄), lithium sulfonylimid trifluoromethane (LiN(CF₃SO₂)₂)) and lithium trifluorosulfonate (CF₃SO₃Li).

14. A battery as claimed in claim 11, wherein the additives are lithium polysulfides having the formula Li₂Sₙ.

15. A battery as claimed in claim 14, wherein the value of n is from 2 to 20, inclusive.

16. A battery as claimed in claim 14, wherein the value of n is from 2 to 12, inclusive.

17. A battery as claimed in claim 14, wherein the value of n is from 12 to 20, inclusive.

18. A battery as claimed in claim 11, wherein the concentration of the one or several lithium salts lies in the range from 0.1 to 90% of a concentration of a saturated solution of the used salt (salts) in an aprotic solvent (solvents mixture).

19. A battery as claimed in claim 14, wherein the concentration of lithium polysulfides is from 0.01M to 90% of a concentration of a saturated solution of the used salt (salts) in an aprotic solvent (solvents mixture).

20. A battery as claimed in claim 11, comprising a positive electrode (cathode) made of metallic lithium or a second lithium-containing alloy.
